(19) United States
(12) Patent Application Publication
(10) Pub. No.: US 2009/0327022 A1
(43) Pub. Date: Dec. 31, 2009

(54) Solicitation Management-Computerized Method to automate Solicitations Processing and Tracking.

(76) Inventor: David Hassan, Mundelein, IL (US)

Correspondence Address: DAVID HASSAN, 27645 PRIMROSE LN., MUNDELEIN, IL, 60060, US

(21) Appl. No.: 12/489,394

(22) Filed: Jun. 22, 2009

Related U.S. Application Data
(60) Provisional application No. 61/074,649, filed on Jun. 22, 2008.

(51) Int. Cl. G06Q 10/00; G06Q 50/00

(52) U.S. Cl. 705/9

(57) ABSTRACT

A method and apparatus for automating the solicitation process for solicitors and organizations. The web based system would facilitate the tracking and management of solicitation information including donation requests, statuses and donor information to help automate the process. Organizations can provide their solicitors and committee members tools to allow them to manage the solicitation process without consuming organization resources in facilitating the solicitation process.

### CROSS-REFERENCE TO RELATED APPLICATIONS

This invention claims priority from Provisional Application No. U.S. 61/074,649

### STATEMENT REGARDING FEDERALLY SPONSORED RESEARCH OR DEVELOPMENT

Not Applicable.

### BACKGROUND OF THE INVENTION

Solicitations for donations are based on paper based manual process. Organizations requesting donations of any type, start by writing a letter and mailing it out to targeted organizations, companies or individuals. They would then rely on individuals related to the soliciting organization to call and follow up on the solicitation letters and to find out the status of the donation from the prospective donors. This is an inefficient process and costly to keep organized and managed for the soliciting organizations.

### BRIEF SUMMARY OF THE INVENTION

To alleviate the problems inherent in the prior art, embodiments of the present invention provide an efficient and effective system and a method for operating a Solicitation Management System. The program relies on a set of standards and integrated processes to facilitate the automating of the Solicitation process.

### DETAILED DESCRIPTION OF THE INVENTION

In one embodiment, a method, a computer program is provided to the Soliciting Organization and to its individual solicitors (i.e. Board Members, Committee Chairs, Solicitation Committee Members, or any one related to the organization),. to Manage (add, update or remove) potential solicitation contacts grouped under the individual solicitors. The Organization and Individual Solicitors can generate an eMail or Mailed document to the group being solicited from within the system. The system will setup a tracking function for the individual solicitor to track the status of the each specific solicitation. The tracking function will allow the individual solicitor to follow up on the solicitation based on timed tickler function, enter the Solicitation response, result or commitment into the tracking database. The individual solicitors are able to generate Thank You letters or emails from within the system for their respective Solicitees. The system will provide each solicitor with full reporting capability to track their solicitations and their impact on the organizations financial bottom line.

The Organization will have a full view of the impact each Solicitor is contributing. The major benefit of this embodiment is the real-time information flow between the Organization and the individual solicitors, which would increase the accountability and impact each solicitor would have on the Organization.

Each Solicitor would have their own view of the Solicitations that are in the pipeline and their status. They will also have all the tools they require to be able to manage the solicitation process electronically, and therefore avoiding the labor intensive paper-based in-efficient solicitation handling.

What is claimed is:

1. A computerized methods for automating handling the solicitation process for solicitors, comprising the steps of:
a. Providing a web-based secure server and website configured to handle the solicitation process;
b. The solicitation management website allows individual solicitors (directly or in-directly working for an organization) to manage their section (constituents that are assigned to the specific solicitors) of the solicitation requests;
c. The website will allow solicitors to submit, track and follow up, manage Solicitee contact info, the solicitee Participation Stages (Moves Management: starting with leads, engagement, closing the deal, and continuous support and relation building);
d. The website will enable the update and tracking of the Solicitation. The system will allow full reporting of the Solicitation process by individual Solicitors and overall for the Organization;
e. The organization would update any transaction information from the solicitees. The information will be automatically updated for the solicitor;
f. The website would allow for managing communication between the solicitor and the solicitee, including send custom Thank You's notes electronically.

2. The method of claim 1 wherein the website allow external solicitors that are considered outsiders to an organization (not fully employed by the organization), access to limited business information of the organization, but key information to manage the solicitation process.
